(19) United States
(12) Patent Application Publication
(10) Pub. No.: US 2007/0171825 A1
(43) Pub. Date: Jul. 26, 2007

(54) System, method, and computer program product for IP flow routing

(75) Inventors: Lawrence G. Roberts, Woodside, CA (US); Alex E. Henderson, Portola Valley, CA (US)

Correspondence Address: Zilka-Kotab, PC, P.O. BOX 721120, SAN JOSE, CA, 95172-1120, US

(73) Assignee: ANAGRAN, INC.

(21) Appl. No.: 11/335,969

(22) Filed: Jan. 20, 2006

(51) Int. Cl. H04J 1/16; H04L 12/28

(52) U.S. Cl. 370/235; 370/351

(57) ABSTRACT

A router system, method and computer program product are provided. In use, it is determined whether a flow associated with a received packet is new. If it is determined that the flow associated with the packet is new, at least a portion of the packet is routed utilizing a first module. If, on the other hand, it is determined that the flow associated with the packet is not new, at least a portion of the packet is routed or switched utilizing a second module that costs at least 10 times less than the first module.

### RELATED APPLICATION(S)

The present application is related to a co-pending application filed coincidently herewith with common inventors under the title “SYSTEM, METHOD, AND COMPUTER PROGRAM PRODUCT FOR CONTROLLING OUTPUT PORT UTILIZATION” and attorney docket number ANA1P002, which is incorporated herein by reference in its entirety for all purposes.

### BACKGROUND AND FIELD OF THE INVENTION

The present invention relates to routers, and more particularly, to routing flows of packets.

### SUMMARY

A router system, method and computer program product are provided. In use, it is determined whether a flow associated with a received packet is new. If it is determined that the flow associated with the packet is new, at least a portion of the packet is routed utilizing a first module. If, on the other hand, it is determined that the flow associated with the packet is not new, at least a portion of the packet is routed or switched utilizing a second module that costs at least 10 times less than the first module.

### BRIEF DESCRIPTION OF THE DRAWINGS

FIG. 1 illustrates a network architecture, in accordance with one embodiment.

FIG. 2 shows a method for flow routing, in accordance with one embodiment.

FIG. 3 shows a router system for flow routing, in accordance with one embodiment.

### DETAILED DESCRIPTION

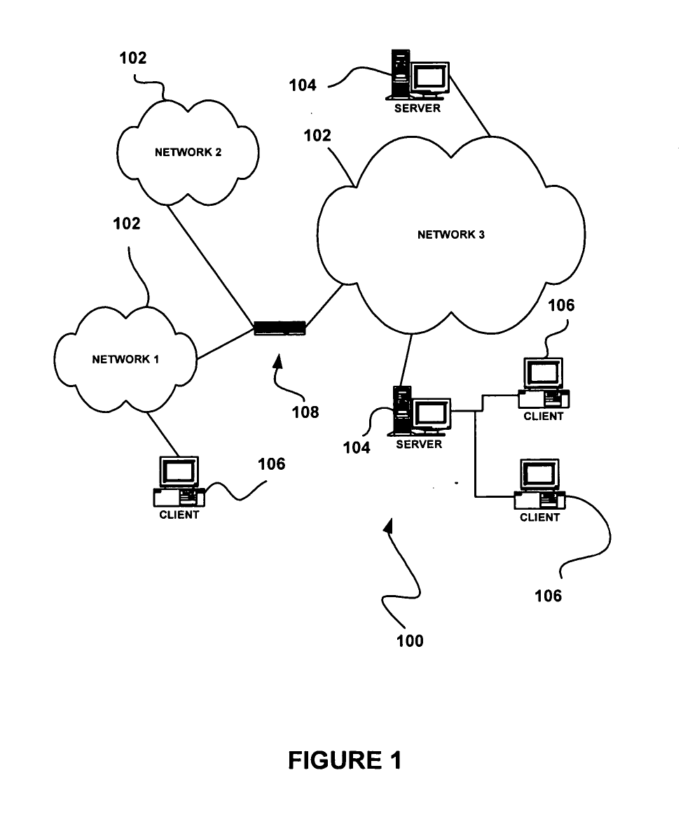

FIG. 1 illustrates a network architecture 100, in accordance with one embodiment. As shown, a plurality of networks 102 is provided. In the context of the present network architecture 100, the networks 102 may each take any form including, but not limited to a local area network (LAN), wireless network, wide area network (WAN) such as the Internet, etc.

Coupled to the networks 102 are server computers 104 which are capable of communicating over the networks 102. Also coupled to the networks 102 and the server computers 104 is a plurality of client computers 106. Such client computers 106 may each include a desktop computer, lap-top computer, hand-held computer, mobile phone, hand-held computer, personal video recorder (PVR), a digital media [e.g. compact disc (CD), digital video disc (DVD), MP3, etc.] player, printer, and/or any other type of logic.

In order to facilitate communication among the networks 102, at least one router 108 is coupled between the networks 102. In the context of the present description, such router 108 may include any hardware and/or software capable of facilitating the communication of packets from one point in the network architecture 100 to another. More information regarding various features for enhancing such functionality will be set forth hereinafter in greater detail.

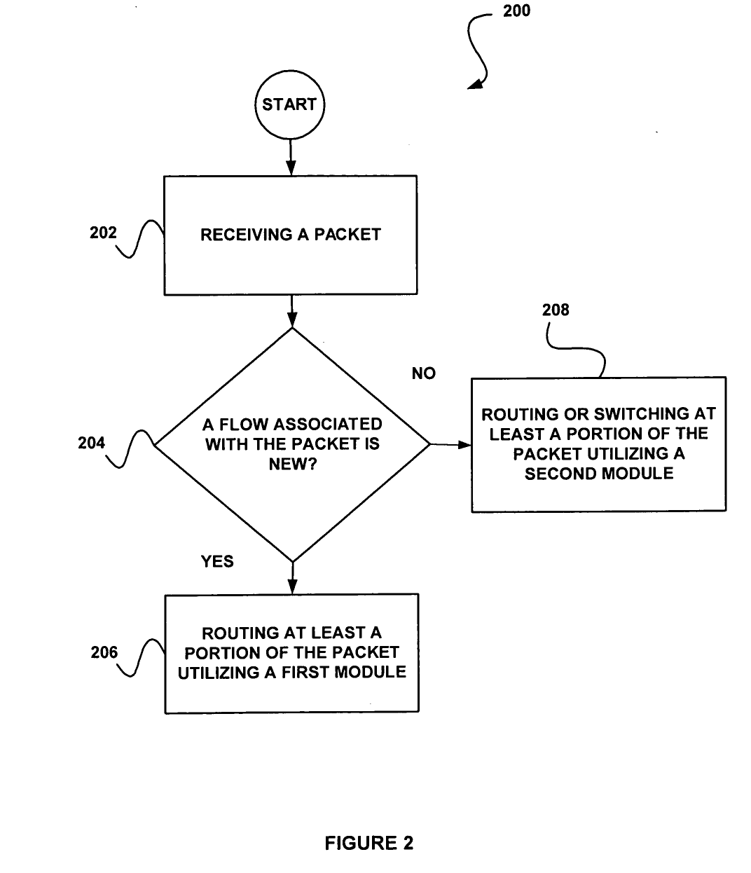

FIG. 2 shows a method 200 for flow routing, in accordance with one embodiment. As an option, the present method 200 may be implemented in the context of the architecture and environment of FIG. 1. Of course, however, the method 200 may be carried out in any desired environment.

As shown, a packet is received in operation 202. In the context of the present description, such packet may refer to any unit of information capable of being communicated in a computer network (e.g. see, for example, the networks 102 of FIG. 1, etc.). For example, in one illustrative embodiment, the packet may include an Internet Protocol (IP) packet.

Next, it is determined whether a flow associated with a received packet is new. See decision 204. In the context of the present description, the term flow refers to a collection of packets that relate to a common data transfer. In various optional embodiments, however, the flow may include a bit-stream of some arbitrary length and constitute a single data transfer. In such embodiments, each flow may be broken into packets for the purpose of facilitating delay reduction and error recovery. Still yet, in the present context, a flow is new if a packet thereof has yet to be received or recognized, or if there is no record thereof (for any reason).

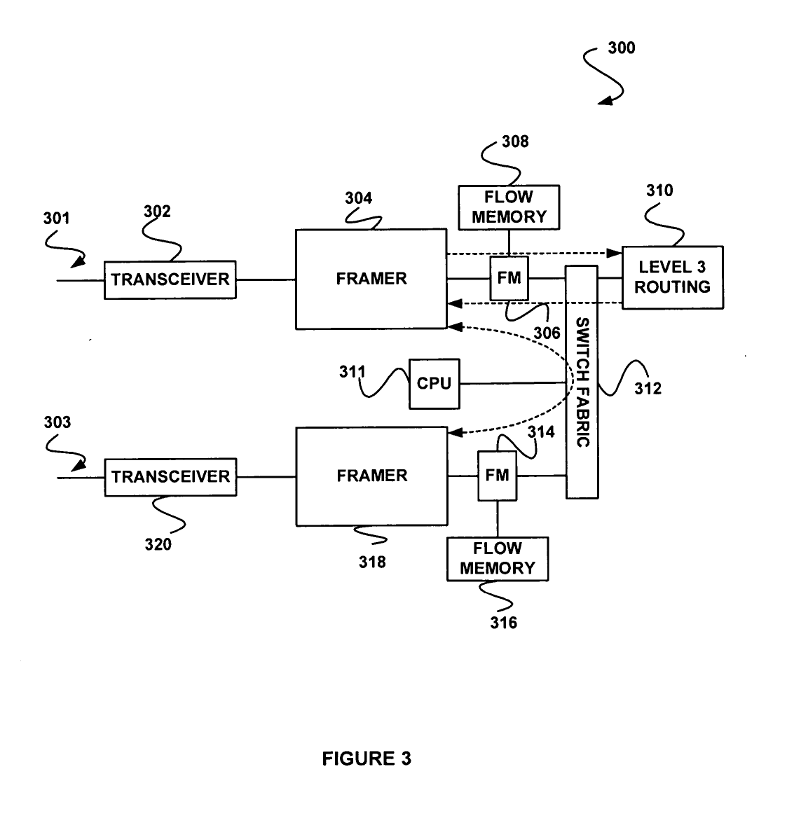

It should be noted that the decision 204 may be carried out in any desired manner. Just by way of example, in some embodiments, such decision may involve extracting a header from the packet received in operation 202, creating a hash utilizing the header, and looking up a flow record, such that the flow is determined to be new if a flow record matching the hash is found. More information regarding such functionality will be set forth during reference to FIG. 3. Such exemplary embodiment, however, is merely illustrative in nature and should not be construed as limiting in any manner. Specifically, the decision 204 may be carried out in any manner that results in a determination that a flow associated with a received packet is new or not.

If it is determined that the flow associated with the packet is new per decision 204, at least a portion of the packet is routed utilizing a first module. Note operation 206. On the other hand, if it is determined that the flow associated with the packet is not new per decision 204, at least a portion of the packet is routed or switched utilizing a second module. Note operation 208.

In the context of the present description, the term routing refers to any communication of packets from one point in a network architecture to another, that involves the identification of a destination address by at least being capable of identifying a “longest prefix” match. Further in the context of the present description, the term switching may refer to any communication of packets from one point in a network architecture to another involving the identification of a destination address without having or using any ability to identify a “longest prefix” match. Thus, switching is unable to support as many destinations as routing.

In various exemplary embodiments that are not to be construed as limiting with respect to the above definition of routing, the aforementioned “longest prefix” match may require only one memory cycle, but may, in other embodiments, require 3-5 memory cycles. Further, the match may, but need not necessarily, be a complete match. Instead, it may involve just enough bytes of the address to determine a desired output port. For example, European communications may be sent to one port so there is no need to keep track of all the Europe addresses, but rather just a first part correlating to Europe, etc.

In other exemplary embodiments that are, again, not to be construed as limiting with respect to the above definition of routing, a second router function may involve determining if traffic to or from certain addresses are to be blocked and/or discarded in relation to a denial of service (DOS) function. Optionally, more than mere addresses may be used to make such decision and an associative memory may be used to accomplish the same. Of course, various other functions may be included, such as a function for prioritizing traffic so that certain types of packets receive a lower delay during the course of traffic shaping, etc.

In still other various exemplary embodiments that are not to be construed as limiting with respect to the above definition of switching, the aforementioned switching may only utilize one field in a packet, and perform only one look up to identify a destination of a packet. Thus, switching, in one embodiment, performs one look up or requires one memory cycle per packet. Thus, in the context of the aforementioned illustrative embodiments, routing may support much larger address domains, DOS, and/or traffic shaping, while switching may not necessarily.

In one embodiment, the first and second module may each include any hardware and/or software whereby the second module costs at least 10 times less than the first module. In various other embodiments, additional cost savings may be provided by including a second module that costs at least 50 times less than the first module, at least 100 times less than the first module, or at least 200 times less than the first module. In the context of the present description, the aforementioned cost may be quantified utilized monetary units, processing units, and/or storage units, since all of these units are intertwined. For example, an increase in monetary units is typically a function of increases in processing and storage capacity.

In another illustrative embodiment (which may or may not meet the definitions of the previous embodiment), the first module may include a network processing unit (NPU). Further, such NPU may include one or more processors capable of routing packets. In contrast, the second module may include a switching integrated circuit. In another embodiment, such switching integrated circuit may include any processor capable of switching packets, but unable to route the same.

To this end, in various optional embodiments, if it is determined that the flow associated with the packet is not new, use of the first module is substantially avoided or simply avoided altogether during the routing or switching of the packet. Thus, the second module (which may involve a lower cost, etc.) may be relied upon when possible, thus freeing up the first module. This, in turn, allows for fewer or a lesser capacity first module(s) to be utilized. Thus, in one embodiment, a cost savings is provided.

Strictly as an additional option, the routing set forth in operation 206 may include routing only a header of the packet utilizing the first module. To this end, routing of a body of the packet associated with a new flow may be avoided for additional efficiency. For example, such option may permit the use of a less expensive first module. More information regarding such optional feature will be set forth hereinafter in greater detail during reference to FIG. 3.

More illustrative information will now be set forth regarding various optional architectures and features with which the foregoing technique may or may not be implemented, per the desires of the user. It should be strongly noted that the following information is set forth for illustrative purposes and should not be construed as limiting in any manner. Any of the following features may be optionally incorporated with or without the exclusion of other features described.

FIG. 3 shows a router system 300 for flow routing, in accordance with one embodiment. As an option, the present system 300 may be implemented in the context of the architecture and environment of FIGS. 1-2. Of course, however, the system 300 may be carried out in any desired environment. Further, the foregoing definitions may equally apply in the present description.

As shown, the router system 300 includes an input trunk 301 and an output trunk 303. The input trunk 301 is coupled to an input transceiver 302 for receiving packets via the input trunk 301 and feeding the same to an input framer 304 for performing packet framing. In one embodiment, such packet framing may refer to the method by which packets are sent over a serial line. For example, framing options for T1 serial lines may include D4 and ESF. Further, framing options for E1 serial lines may include CRC4, no-CRC4, multiframe-CRC4, and multiframe-no-CRC4.

Further included is an input flow manager 306 coupled between the input framer 304 and a switching fabric architecture 312. In use, the input flow manager 306 may carry out the functionality associated with the method 300 of FIG. 3. To facilitate such use, in a manner that will soon become apparent, the input flow manager 306 may further be coupled to input flow memory 308. In the present embodiment, the switching fabric architecture 312 may include hardware (e.g. switching integrated circuit, etc.) and/or software that switches incoming packets (e.g. moves incoming packets out via an appropriate output port, etc.) in a manner that will soon become apparent. For controlling such switching fabric architecture 312, a central processing unit 311 may be in communication therewith.

Still yet, an NPU 310 may be in communication with the input flow manager 306 and/or switching fabric architecture 312 for routing incoming packets in a manner that will soon become apparent. Further included is an output flow manager 316 coupled between the switching fabric architecture 312 and an output framer 318. Similar to the input flow manager 306, the output flow manager 316 includes output flow memory 316 for performing similar functions.

For the reasons discussed earlier, the switching fabric architecture 312 may cost at least 10 times less than the NPU 310. In one embodiment, the switching fabric architecture 312 may include one or more simple Ethernet switching chips which support 100 Gbps and are much less expensive with respect to the NPU 310.

Further, the output flow manager 316 may further be optionally equipped with output flow management functionality. More information regarding such functionality may be found in a co-pending application filed coincidently herewith with common inventors under the title “SYSTEM, METHOD, AND COMPUTER PROGRAM PRODUCT FOR CONTROLLING OUTPUT PORT UTILIZATION” and attorney docket number ANA1P002, which is incorporated herein by reference in its entirety for all purposes.

Finally, the output framer 318 is coupled to an output transceiver 320 which communicates via the output trunk 303. While the various components are shown to be included in a single package associated with the router system 300, it should be noted that such components may be distributed in any desired manner.

In use, the input flow manager 306 may be used to look up a flow associated with an incoming packet before being sent to the NPU 310. Specifically, the input flow manager 306 extracts a header of the packet. In one embodiment, such header may include various fields including, but not limited to a destination address, source address, protocol, destination port, source port, and/or any other desired information.

Next, one or more of the fields are combined in the form of a hash. As an option, such hash may take the form of a 32-bit flow identifier. The input flow manager 306 then uses the hash (e.g. a lower 21 bits of the 32-bit flow identifier, etc.), and does a memory look up in a hash table stored in the input flow memory 308. Specifically, in one exemplary embodiment, a binary tree is followed using a remaining 11 bits of the 32-bit flow identifier until a pointer to a flow record is located in the input flow memory 308 that makes an exact match with the destination address, source address, protocol, destination port, and source port, etc. Such record (if it exists) constitutes a flow record for the identified flow.

If no such flow record exists that is an exact match with the destination address, source address, protocol, destination port, and source port, the present flow may be considered a new flow, and the associated packet may be sent to the NPU 310 to be routed. For further efficiency purposes, only IP and Layer-4 headers of the packet may optionally be forwarded to the NPU 310 for routing purposes. In one embodiment, such routing may involve Level-3 packet routing.

As mentioned earlier, by only forwarding the headers (and not the packet bodies), a required capacity and associated expense of the NPU 310 may be reduced. Since the average packet is 650 bytes and the header is only 40 bytes, the traffic through the NPU 310 may, in one embodiment, be reduced by at least 16:1. To this end, in one embodiment, at least 8:1 NPU cost savings may be provided by the above technique.

One result of the aforementioned routing includes an internal route to an ideal output port that is to be used for the present flow. It may also determine DOS information for the flow. Still yet, it may also compute a rate that the flow should initially use.

The foregoing results (e.g. route, DOS information, rate, etc.) may be returned to the input flow manager 306 so that such information may be saved in an associated flow record in the input flow memory 308. Thereafter, the packet may be forwarded through the switching fabric architecture 312 to the output flow manager 314 where the flow information may be stored in the output flow memory 316. Then, the packet is forwarded to the output framer 318 and the output transceiver 320 to be sent to the output trunk 303.

On the other hand, if, during the course of the aforementioned hash look-up, the packet does match the destination address, source address, protocol, destination port, and source port in a flow record, the packet may be considered a later packet in an already-identified flow. Thus, the packet need not necessarily Instead, the packet may be forwarded through the switching fabric architecture 312 to the output flow manager 316 where, again, information associated with the flow may be stored in the output flow memory 316. Again, the packet may then be forwarded to the output framer 318 and to the output transceiver 320 to be sent to the output trunk 303.

As mentioned previously, the output flow manager 316 may further be optionally equipped with output flow management functionality. Again, more information regarding such functionality may be found in a co-pending application filed coincidently herewith with common inventors under the title “SYSTEM, METHOD, AND COMPUTER PROGRAM PRODUCT FOR CONTROLLING OUTPUT PORT UTILIZATION” and attorney docket number ANA1P002, which is incorporated herein by reference in its entirety for all purposes.

Thus, the above process recognizes currently active flows and bypasses expensive routing. When the packet represents a new flow, the packet (or just the 40-byte packet header) may be sent to the NPU 310 which routes the header, performs required DOS and access control checks, determines the QoS desired, and then returns the route and QoS to the input flow manager 306. The input flow manager 306 then creates a flow record and stores the route and other flow information. It then forwards the packet and all subsequent packets in that flow to the less expensive switching fabric architecture 312. The output frame manager 316 then delivers them to a desired output port.

Since required NPU resources is minimized by diverting processing to the switching fabric architecture 312, the present technique optionally allows the NPU capacity for a 96 Gbps router to be reduced from 96 Gbps to 5 Gbps, in one exemplary embodiment. Since the average flow consists of 14 packets, each with 650 bytes, this means that the number of bit per second to be processed by the NPU 310, in one embodiment, is 227 times less than in a traditional packet router. The reduction of 20:1 in NPU processing capacity is thus considerably overpowered. However, this allows for statistical traffic variations and further allows for one NPU 310 to optionally support two systems if one NPU 310 fails. Of course, other designs may reduce this NPU capacity even further when smaller units become available.

One basis of the above technique is rooted in the fact that, in IP traffic, packets with the same destination address, source address, protocol, destination port, and source port belong to the same flow and may be routed the same and have the same DOS result. In one embodiment, the same parameters may be reused after a significant timeout period (e.g. minutes). Thus, such embodiment does not necessarily require that flow state information be maintained for more than 10 seconds if no packets are received. To this end, a quantity of state information may be limited to active or recently active flows, which avoids confusing new flows when the parameters are eventually reused. In IPv6, the last three parameters may be encrypted, but a flow label may be substituted which, together with the destination address and the source address, constitutes a unique flow.

In use, a significant amount of routing cost is removed, and performance of the router may be improved in many optional ways. Again, this is done, in one embodiment, by routing only the header of the first packet of a flow, saving the relevant route and state information, and then switching all the packets of the flow based on that state information rather than routing each packet. Until recently, the memory to keep such state information on each flow was uneconomical and thus not considered. Today, however, the cost of memory has fallen sufficiently such that this approach is much less expensive than sending every packet individually through the NPU. Also, there are many optional benefits obtained from saving the flow state information that improve the network efficiency, reduce buffering memory requirements, and otherwise improve the performance of the router.

While various embodiments have been described above, it should be understood that they have been presented by way of example only, and not limitation. For example, any of the network elements may employ any of the desired functionality set forth hereinabove. Thus, the breadth and scope of a preferred embodiment should not be limited by any of the above-described exemplary embodiments, but should be defined only in accordance with the following claims and their equivalents.

1. A method, comprising:
receiving a packet;
determining whether a flow associated with the packet is new;
if it is determined that the flow associated with the packet is new, routing at least a portion of the packet utilizing a first module; and
if it is determined that the flow associated with the packet is not new, routing or switching at least a portion of the packet utilizing a second module that costs at least 10 times less than the first module.

2. The method of claim 1, wherein the first module includes a network processing unit (NPU).

3. The method of claim 1, wherein the second module includes hardware.

4. The method of claim 1, wherein the second module includes software.

5. The method of claim 1, wherein the second module includes hardware and software.

6. The method of claim 1, wherein the second module includes a switching integrated circuit.

7. The method of claim 1, wherein the routing or switching includes routing.

8. The method of claim 1, wherein the routing or switching includes switching.

9. The method of claim 1, wherein, if it is determined that the flow associated with the packet is not new, use of the first module is substantially avoided during the routing or switching of the packet.

10. The method of claim 9, wherein, if it is determined that the flow associated with the packet is not new, use of the first module is avoided during the routing or switching of the packet.

11. The method of claim 1, wherein the second module costs at least 50 times less than the first module.

12. The method of claim 11, wherein the second module costs at least 100 times less than the first module.

13. The method of claim 12, wherein the second module costs at least 200 times less than the first module.

14. The method of claim 1, wherein the determining includes extracting a header from the packet.

15. The method of claim 14, wherein the determining includes creating a hash utilizing the header.

16. The method of claim 15, wherein the determining includes looking up a flow record utilizing the hash.

17. The method of claim 16, wherein the flow is determined to be new if a flow record matching the hash is found.

18. The method of claim 1, wherein the routing includes routing only a header of the packet utilizing the first module.

19. A computer program product embodied on a computer readable medium, comprising:
computer code for receiving a packet;
computer code for determining whether a flow associated with the packet is new;
computer code for routing at least a portion of the packet utilizing a first module, if it is determined that the flow associated with the packet is new; and
computer code for routing or switching at least a portion of the packet utilizing a second module that costs at least 10 times less than the first module, if it is determined that the flow associated with the packet is not new.

20. A router comprising:
a flow manager for determining whether a flow associated with a packet is new;
a first module in communication with the flow manager, the first module for routing at least a portion of the packet, if it is determined that the flow associated with the packet is new; and
a second module in communication with the flow manager, the second module for routing or switching at least a portion of the packet utilizing a second module that costs at least 10 times less than the first module, if it is determined that the flow associated with the packet is not new.

21. A computer program product embodied on a computer readable medium, comprising:
computer code for receiving a packet;
computer code for determining whether a flow associated with the packet is new;
computer code for routing at least a portion of the packet utilizing a network processing unit (NPU), if it is determined that the flow associated with the packet is new; and
computer code for switching at least a portion of the packet utilizing only switching circuitry, if it is determined that the flow associated with the packet is not new.

22. A method, comprising:
receiving a packet;
determining whether a flow associated with the packet is new;
routing at least a portion of the packet utilizing a network processing unit (NPU), if it is determined that the flow associated with the packet is new; and
switching at least a portion of the packet utilizing only switching circuitry, if it is determined that the flow associated with the packet is not new.

23. A computer program product embodied on a computer readable medium, comprising:
computer code for receiving a packet;
computer code for determining whether a flow associated with the packet is new;
computer code for routing at least a portion of the packet utilizing a network processing unit (NPU), if it is determined that the flow associated with the packet is new; and
computer code for routing or switching at least a portion of the packet utilizing a switching integrated circuit other than the NPU, if it is determined that the flow associated with the packet is not new.

24. A method, comprising:
receiving a packet;
determining whether a flow associated with the packet is new;
routing at least a portion of the packet utilizing a network processing unit (NPU), if it is determined that the flow associated with the packet is new; and
routing or switching at least a portion of the packet utilizing a switching integrated circuit other than the NPU, if it is determined that the flow associated with the packet is not new.
